(19) United States
(12) Patent Application Publication
(10) Pub. No.: US 2020/0318038 A1
(43) Pub. Date: Oct. 8, 2020

(54) BAR SOAP WITH CORE ELEMENT

(71) Applicants: Rodolpho Cezar Formagio PARRA, Maringá (BR); Hilton Lee Isfair CARDOSO, Maringá (BR)

(72) Inventors: Rodolpho Cezar Formagio PARRA, Maringá (BR); Hilton Lee Isfair CARDOSO, Maringá (BR)

(21) Appl. No.: 16/778,957

(22) Filed: Jan. 31, 2020

(30) Foreign Application Priority Data
Apr. 2, 2019 (BR) 2020190067131

(51) Int. Cl. C11D 17/00; C11D 17/04

(52) U.S. Cl. CPC C11D 17/0047; C11D 17/04

(57) ABSTRACT

A bar soap with a composite structure that integrates a core element made of recyclable and/or biodegradable material surrounded by a layer of soap to maintain a sufficiently large size of the soap, allowing easy handling by users and offering users an eco-friendly product that prevents soap residues from contaminating the environment.

### FIELD OF THE INVENTION

The present disclosure relates to toiletries in general, and more particularly, to bar soap comprising a core element of solid or hollow construction, made of recyclable and/or biodegradable material, and fully surrounded by a layer of soap.

### BACKGROUND OF THE INVENTION

Current state of the art bar soaps used for personal care gradually wear away as a result of routine use on body parts. Over time, the initial geometry of the bar soap is partially or fully modified as the bar soap decreases in size or disintegrates into small chunks. At a certain point, this tendency to wear away or disintegrate results in the bar soap having very small dimensions or breaking into small pieces, making it difficult, if not impossible, to be held in users' hands.

When the bar soap is that small in size, it frequently slips from the hands of the users to the floor of shower stalls where it is washed down the drain. The disposal of soap leftovers in sewer lines, even in small amounts, can generate a considerable amount of soap residue that increases environmental contamination as it is released into sewer lines, rivers and waterfalls.

It should be noted that most bar soaps are essentially made of a raw, recyclable material, allowing soap residues to be collected and reused to form new soap without causing harm to the environment. Nevertheless, where possible, environmental contamination should be avoided or decreased.

Given these issues, it has become essential for users to have a versatile, practical, safe, and ergonomic design for bar soaps for personal care that prevents the soap from becoming too small or fragmenting into tiny pieces with routine use. In other words, what is required is a bar soap that maintains dimensions large enough to be handled by users and is not washed down the drain into sewer lines.

### SUMMARY OF THE INVENTION

The present disclosure provides a bar soap that is designed to have a simple and robust structure with minimal components for simple, safe and optimized application. This structure, combined with practical manufacturing, generates a practical and efficient bar soap with a composite structure that integrates a core element surrounded by a layer of soap to maintain the integrity and a sufficiently large size of the soap, allowing easy handling by users, and offering users an eco-friendly product that prevents soap residues from ending up in sewer lines.

The bar of soap for personal care has a composite structure and design of great efficiency, functionality, strength, durability, versatility, safety, ergonomics and hygiene due to excellent technical qualities, which provide advantages and improvements in the use of bar soaps for personal care, and whose general characteristics differ from the structure and models of other bar soaps known in the current state of the art.

The bar soap of the present disclosure is a modern, efficient, safe and functional bar soap with a composite structure formed by a set of properly incorporated physical-chemical and personal care solutions. The bar soap has a structure of high durability and strength and contains a properly integrated and symmetrically arranged core element as a structuring element for a layer of soap that surrounds the core element. The shape and arrangement of the elements can easily be adapted for a variety of bar soaps and users.

The bar of soap of the present disclosure with a its composite structure makes it possible to solve some of the main drawbacks of other structures and models of bar soap known in the state of the art, including the limitations on use and application, low efficiency and performance, frequent personal accidents, low safety, large deterioration and fragility, very low durability and strength, and high product waste, i.e., not eco-friendly.

### BRIEF DESCRIPTION OF THE DRAWINGS

The objectives, advantages and other important characteristics of the bar soap of the present disclosure is more easily understood when read together with the attached figures, in which:

FIG. 1 is a perspective view of a bar soap with core element.

FIG. 2 is a perspective view of the components of the bar soap.

FIG. 3A is a perspective view of the bar soap with a solid core element.

FIG. 3B is a cross-sectional view of the bar soap of FIG. 3A.

FIG. 4 is another cross-sectional view of the bar soap of FIG. 3A.

FIG. 4A is a perspective view of the bar soap with a hollow core element.

FIG. 4B is a cross-sectional view of the bar soap of FIG. 4A.

FIG. 4C is another cross-sectional view of the bar soap of FIG. 4A.

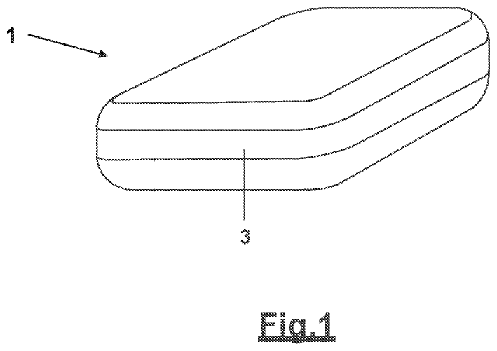

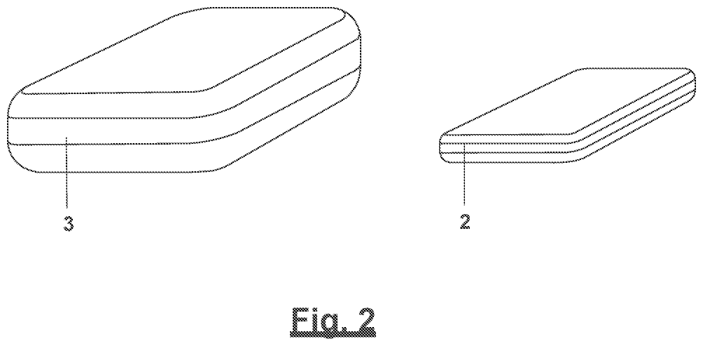

### DETAILED DESCRIPTION OF THE INVENTION

[0019]Figure 1 shows a bar soap (1) comprising at least one core element (not shown) with external faces that are surrounded by a layer of soap (3). In FIG. 2, the components of the bar soap are depicted separately. FIG. 2 shows a core element (2) made of a recyclable and/or biodegradable material, which functions to provide structure for the bar soap (1). A layer of soap (3) surrounds the external faces of the core element (2), forming the exterior of the bar soap (1).

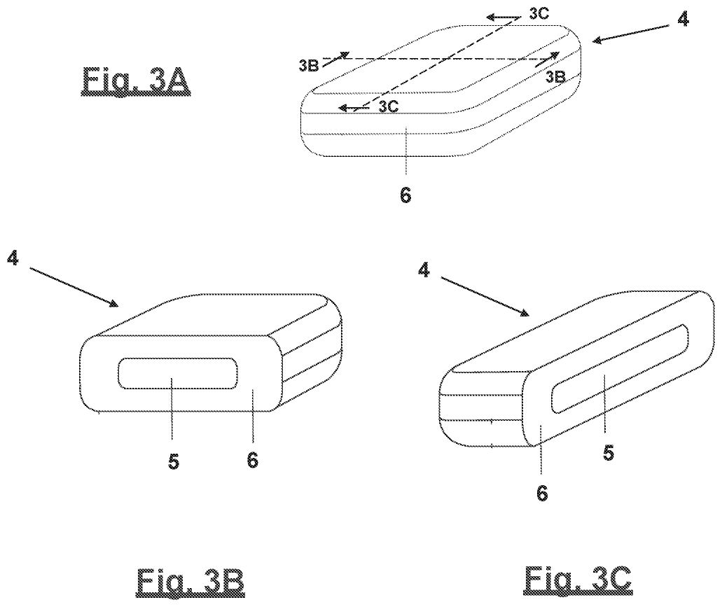

In one embodiment of the present invention, a bar soap (4) has a solid core element (5), as seen in FIGS. 3A, 3B and 3C. The solid core element (5) is found in the center of the bar soap (4), with external faces that are surrounded by a layer of soap (6).

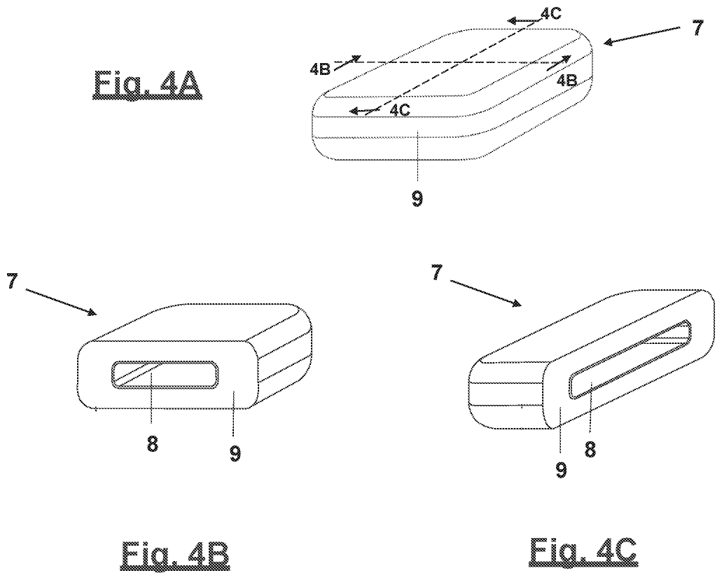

In another embodiment of the present invention, a bar soap (7) has a hollow core element (8) in the center, the hollow core element (8) having external faces that are surrounded by a layer of soap (9) as seen in FIGS. 4A, 4B and 4C. The hollow core element (8) can be filled with products such as bath salts, body oils, body lotions, moisturizers, deodorants and colored bath foams.

The particular structure of the bar soap gives the bar soap high durability and strength. The shapes and arrangement of the core element and the layer of soap are not limited to the shapes and arrangements shown in the Figures. The core element and the layer of soap can be adapted to different types of bar soaps with various shapes, arrangements, colors, sizes and scents.

The bar soap can further include an elastic band or cord attached to at least one end of the core element, for the purpose of keeping the bar soap suspended from the users' hands or wrists, or for hanging the bar soap on a wall hook.

It should be noted that different types of accessories can be added to the bar soap to facilitate its use or storage when not in use.

Since the components of the bar soap with are fully integrated, the manufacturing process is fairly practical as nothing unfastens and breaks or tears, thus achieving a high level of performance and efficiency, combined with high durability and safety. Once the components are fully integrated, the components remain fitted together and cohesive so they do not come loose when in use

Considering the foregoing, the bar soap of the present disclosure is a personal care product that will be well received by users. The bar soap has several advantages, including: great safety, reliability and ease of application; great efficiency and performance in its application; high comfort, convenience and practicality to users; extremely high general resistance and durability, coupled with low or no wear of the set as a whole; completely affordable costs which provides excellent cost-benefit ratio; practical and safe use by any user; wide reach range; great adaptability to several types of personal care procedures for soaps; great overall mobility and flexibility of the set; high operational ergonomics; reduction of soap waste; and the certainty of having a bar soap that fully meets the laws and regulations in force and the basic conditions necessary for its application.

Due to its features, the bar soap is versatile, efficient, practical and safe to be applied in a variety of personal care procedures by the most diverse types of users and in the most diverse types of locations. The bar soap is also characterized by great ease of application and handling. However, the measures and quantities required for the bar soap may vary according to the general needs of each application.

1. A bar soap comprising at least one core element with external faces surrounded by a layer of soap.

2. The bar soap of claim 1, wherein the at least one core element is made of a recyclable or biodegradable material.

3. The bar soap of claim 1, wherein the at least one core element is solid.

4. The bar soap of claim 1, wherein the at least one core element is hollow.

5. The bar soap of claim 1, wherein the at least one core element is located in a center of the bar soap.

6. The bar soap of claim 1, further comprising an elastic band or cord attached to at least one end of the at least one core element.
